(19) United States
(12) Patent Application Publication
(10) Pub. No.: US 2015/0090624 A1
(43) Pub. Date: Apr. 2, 2015

(54) REUSABLE DESIGN SWATCH APPARATUS AND SYSTEM

(71) Applicant: LIBERTY HARDWARE MFG. CORP., Winston-Salem, NC (US)

(72) Inventors: Kelly Kovacs, Jamestown, NC (US); Earl David Forrest, Asheboro, NC (US); Amy Tagle, Winston-Salem, NC (US)

(73) Assignee: LIBERTY HARDWARE MFG. CORP., Winston-Salem, NC (US)

(21) Appl. No.: 14/041,433

(22) Filed: Sep. 30, 2013

(51) Int. Cl. B44D 3/00; B44D 3/12; G09F 5/00; C09J 7/02; C09J 153/02

(52) U.S. Cl. CPC B44D 3/003; C09J 7/0285; C09J 7/0246; C09J 153/02; G09F 5/00; B44D 3/12; C09J 2201/122; C09J 2201/606; C09J 2453/00; C09J 2467/006; G09F 2003/0272
USPC 206/459.5; 428/195.1; 428/354; 428/483

(57) ABSTRACT

A swatch assembly includes a substrate with a decorative sample thereon, and an adhesive layer at least partially covering the substrate. The adhesive layer is a reversible adhesive configured to releasably and temporarily attach the design swatch to an underlying surface, leave the underlying surface unmarked after removal, and retain an adhesion property for a plurality of adhesion cycles. A design system includes a first design swatch with a first substrate and a first adhesive layer being a reversible adhesive, and a second design swatch with a second substrate and a second adhesive layer being a reversible adhesive. A display apparatus for a design swatch includes a substrate layer, an adhesive layer being a reversible adhesive, and an attachment feature supported by the substrate layer and configured to receive a design swatch for display against an underlying surface.

### TECHNICAL FIELD

Various embodiments relate to a swatch or system of swatches for use in interior design.

### BACKGROUND

When decorating a room, various colors and designs are selected, for example, paint colors, wallpaper designs, drapery or upholstery patterns, etc. Often, the color or design is viewed or tested in the room before the room or wall is painted or decorated. Rooms and other decorated spaces have varying ambient light exposure, interior lighting, or decorations, and other factors that cause a color or design to appear differently when displayed in the space compared to in a retail store. The color or design may additionally need to coordinate or complement other existing or planned decoration within the space.

For example, with selecting a paint color, it is common to test the color or design, for example, by holding up a paint card, or paint color paper swatch, that displays one or more colors of paint in varying shades of a color or preselected colors. These paint swatches allow for selection from a variety of available colors, for example, when deciding on a color to paint an interior room, interior wall, trim, house exterior, or the like. The swatch is typically provided at no cost to provide a visualization of what the paint may look like on the wall before committing to the color and making a paint purchase. For example, the swatch may represent one of thousands of colors offered by a paint manufacturer or retail store where the paint is custom color matched to the selected shade to provide such a wide range of paint colors on an as-needed basis. These custom color paints are often not returnable, and therefore an emphasis may be placed on selecting an acceptable paint color before the paint is mixed and purchased. When only a limited number of standard colors is available from a manufacturer or retailer, the paints may be returnable; however, custom color matching or a color design consultant may not be available to work with the user or consumer on paint selection. In this scenario, paper color swatches may be the only tool the user has for color selection short of purchasing a sample size can and painting a small portion of the wall surface.

It may be difficult to determine if a paint color or other decorative swatch is acceptable as the displayed color on a standard paper color swatch is small in size. Also, if the user is holding the swatch against the wall, it may be difficult to have a perspective on the overall look and feel of the color in the room, as a single user cannot stand back to view a different perspective. The user can also tape the swatch against the wall; however, the tape may cover some of the color on the swatch making the swatch even smaller in appearance. Also, the tape may leave residue or marking on the walls that may need to be cleaned later, or pull underlying preexisting paint off of the walls, leading to additional preparation work. A section of the color or design may be placed on the wall by physically painting a section of the wall. This allows for the user to better decide on the look and feel of the color in the room to determine if it is acceptable; however, if the user dislikes the color, they need to paint over it later, which may be difficult for darker shades and is additional work for the user. Also, after a paint can is opened, the user may not be able to return it or exchange it for a different color.

### SUMMARY

In an embodiment, a swatch assembly is provided with a substrate having a first side with a decorative sample thereon and a second side. An adhesive layer at least partially covers the second side of the substrate. The adhesive layer is a reversible adhesive configured to releasably and temporarily attach the design swatch to an underlying surface and leave the underlying surface unmarked after removal. The reversible adhesive retains an adhesion property for a plurality of adhesion cycles.

In another embodiment, a design system is provided with a first design swatch and a second design swatch. The first design swatch has a first substrate including a first side having a first decorative sample thereon and a second side, and a first adhesive layer. The first adhesive layer at least partially covers the second side of the first substrate, and is a reversible adhesive configured to releasably and temporarily attach the first design swatch to an underlying surface, leave the underlying surface unmarked after removal, and retain an adhesion property for a plurality of uses. The second design swatch has a second substrate including a first side having a second decorative sample thereon and a second side, and a second adhesive layer. The second adhesive layer at least partially covers the second side of the second substrate, and is configured to releasably and temporarily attach the second design swatch to an underlying surface, leave the underlying surface unmarked after removal, and retain the adhesion property for a plurality of uses.

In yet another embodiment, a display apparatus for a design swatch is provided with a substrate layer having a first side and a second side, an adhesive layer, and an attachment feature. The adhesive layer at least partially covers the second side of the substrate layer. The adhesive layer is a reversible adhesive configured to releasably and temporarily attach the apparatus to an underlying surface and leave the underlying surface unmarked after removal. The reversible adhesive retains an adhesion property for a plurality of uses. The attachment feature is supported by the substrate layer and is configured to receive a design swatch adjacent to the first side for display against the underlying surface.

Various embodiments of the present disclosure have associated non-limiting advantages. For example, a removable and replaceable design or color swatch or system of swatches is provided. The consumer can temporary attach a selected swatch to the wall to assist in the design process or color selection process. The swatch or apparatus for displaying the swatch includes a reversible adhesive material that allows for the easy removal of the swatch or apparatus from the wall or underlying surface without leaving residue or marks. Also the reversible adhesive retains its adhesive properties over many cycles of use and over time, which allows the swatch or apparatus to be used in various location and a multitude of times.

### BRIEF DESCRIPTION OF THE DRAWINGS

FIG. 1 illustrates a perspective view of a system of design swatches according to an embodiment;

FIG. 2 illustrates a sectional view of a design swatch of the system of FIG. 1;

FIG. 3 illustrates a perspective view of a paint container having a design swatch according to an embodiment;

FIG. 4 illustrates a perspective front view of a swatch display apparatus according to an embodiment;

FIG. 5 illustrates a side view of the apparatus of FIG. 4; and

FIG. 6 illustrates a perspective view of the apparatus of FIG. 4 while displaying a design swatch.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

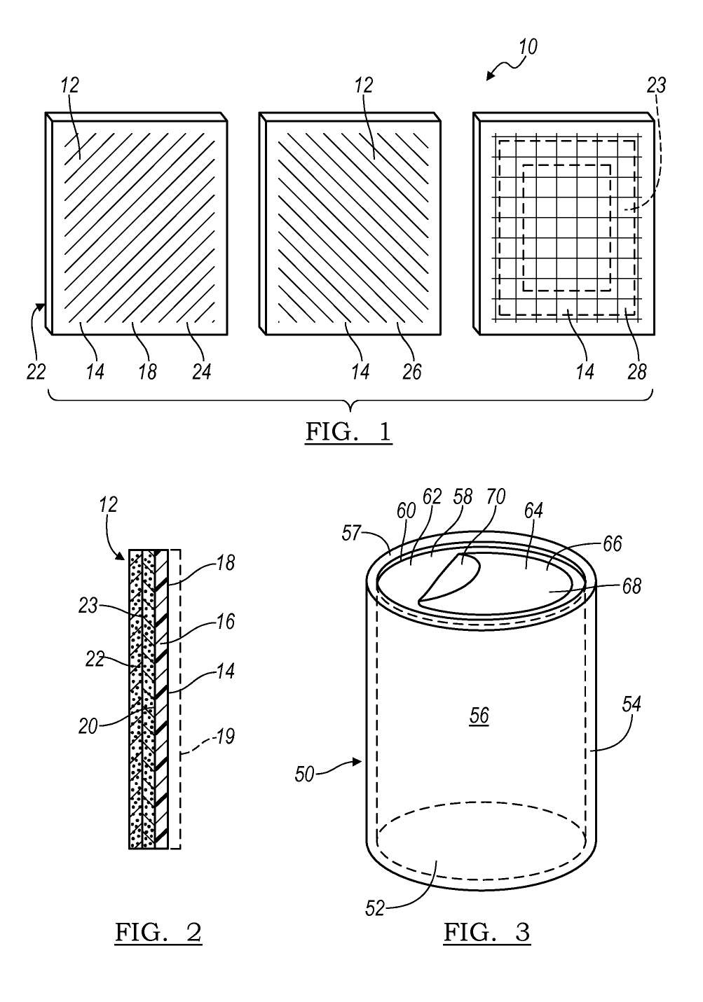

FIG. 1 illustrates a system or kit of design swatches 10 which includes one or more swatches 12. Three swatches 12 are shown, although any number of swatches is contemplated. Each swatch 12 is removable and replaceable and may be offered separately from paint or the bulk design product.

Each swatch 12 has a substrate layer 14. Each substrate 14 has a visible surface that appears as the design product or is coated or covered with a design product or decorative sample. In one embodiment, the substrate 14 appears as a paint color sample. In other embodiments, the substrate 14 is covered with or appears as a wallpaper sample, a tile sample, a cloth sample for upholstery or drapery, a sample wood stain or finish card, or other design or decoration selection sample.

The system 10 may include a single swatch 12 with a single paint color or other design sample. The system 10 may include a number of swatches 12 with various paint colors and/or other samples. For example, the system 10 may have multiple swatches 12 with complementary or contrasting paint color samples that are either selected by the user, or are packaged together as suggested color combinations. The paint colors may also be provided in variety of finish gloss levels, including, but not limited to, flat, matte, eggshell, satin, silk, semi-gloss, and high gloss. The paint colors may be provided for various paint types including, but not limited to, latex, oil based, etc. In another example, the system 10 may include any combination of paint color swatches, wallpaper swatches, tile swatches, and the like.

FIG. 2 illustrates a sectional view of one of the swatches 12 in the system 10 of FIG. 1. The swatch 12 has a substrate layer 16 with a first side 18 and a second side 20. The substrate layer 16 may be made from a thermoplastic polymer such as polyethylene terephthalate (PET) or the like. Alternatively, the substrate layer 16 may be made from paper. The substrate layer 16 may be color matched to represent the selected color of paint, or alternatively, may include a thin layer 19 of the paint on the first side 18 of the swatch 12. In other embodiments, the substrate layer 16 is provided by a sample section of wallpaper, tile, or the like. In further embodiments, a wallpaper sample 19, tile sample, or the like is placed over the first side 18 of the layer 16 to provide a visible outer surface showing the decorative sample. The design sample may extend over the entire first side 18 such that the user only sees the design sample when the swatch 12 is being used. The substrate layer 16 may be flexible to allow for the sample swatch 12 to peeled off of an underlying surface or to conform its shape to a curved underlying surface.

The second side 20 of the substrate layer 16 of the swatch is at least partially coated or covered with an adhesive layer 22. The adhesive layer 22 may entirely cover the second side 20 of the swatch 12, or may only cover a portion of the second side 20. In one embodiment, the adhesive layer 22 is provided as a pattern on the second side 20 of the layer 16. For example, the adhesive layer may be provided as a band of adhesive 23 that is adjacent to the perimeter of the swatch 12, as shown for one swatch in FIG. 1.

The adhesive layer 22 is made from a reversible adhesive material. The reversible adhesive material may be a block copolymer. The reversible adhesive material may have material properties that provide for a shear strength that is higher than a peel strength when in use. For example, the dynamic shear strength may be in the range of 1.0-5.0 lbs/inch of width, and the peel strength may be 0.01-0.05 lbs/inch of width (or may be 20-500 times greater). This allows the swatch 12 to remain affixed to an underlying surface such as a vertical wall, while making the swatch easy to remove by the user.

The adhesive layer 22 may be a thermoplastic elastomer, such as a styrene thermoplastic elastomer. For example, the adhesive layer 22 may include a thermo plastic elastomer (TPE), thermo plastic rubber (TPR), a styrene-butadiene styrene (SBS) block copolymer, or the like. According to one embodiment, the adhesive layer 22 includes the following compositions or composition ranges by weight: 100 parts styrene-ethylene-butadiene-styrene (SEBS) block co-polymer, 100-300 parts hydrogenated naphthenic oil, 100-300 parts white oil, 0-10 parts petroleum adhesion promoter resin, 1-5 parts polypropylene resin, 2-10 parts assistant agent. In one embodiment, the adhesive layer may be a G or D series product from Kraton Company, or a YH series product from Balin Huaxing Petrochemical Ltd. in Yueyang China. In another embodiment, the adhesive layer may be from Ren-River Rubber Products as described in U.S. patent applicant Ser. No. 13/390,689 by Wang filed on Feb. 15, 2012 and incorporated by reference in its entirety herein. The reversible adhesive may also be an adhesive material as described in International Application No. PCT/US2011/057309 by Crosby et al. filed Oct. 21, 2011 and incorporated by reference in its entirety herein. Other suitable reversible adhesives are also contemplated for use with the swatch.

The swatch 12 may have an adhesive promoter layer 23 positioned between the adhesive layer 22 and the substrate layer 16 to facilitate a bond between the layers 16, 22. Alternatively, a clear adhesive 23 may be used between the layers 16, 22 and be suitable to bond the layers. In other embodiments, layer 23 may be omitted such that the reversible adhesive layer 22 is directly bonded to the substrate layer 16.

A release paper (not shown) may be used to cover the exposed side of the adhesive layer 22 during transportation and/or storage. The release paper may act to protect the adhesive layer 22.

The user or consumer obtains a system 10, and places one or more swatches 12 on a surface to be decorated. For example, in a room to be painted, the user may place a paint color swatch 24 against a wall. The user places the adhesive layer 22 of the swatch 24 against the wall and then provides light pressure to the first side 18 of the swatch 24 such that air between the adhesive layer 22 and the wall is generally removed, and the swatch 24 adheres to the wall or other underlying surface. The user may also place additional swatches 26, 28 adjacent to the swatch 24 to provide a visualization of a design or decoration scheme. In one example, swatch 24 provides a visible display of a first color, such as a wall color; swatch 26 provides a visible display of a second color, such as an accent wall color; and swatch 28 provides a visible display of a third color, such as a trim color.

The swatches 24, 26, 28 may be left on the underlying surface for any length of time including seconds, minutes, hours, days, or longer. The user may leave the swatches on the underlying surface over a twenty four hour period in order to view the swatches in the room at various ambient or environmental light levels or exposures, and under various interior lighting. The swatch 12 may be made from flexible materials such that the swatch 12 may be placed over a curved wall or the like and conform and adhere to the underlying surface.

In order to remove a swatch 12, the user takes an edge of the swatch 12 and peels it away from the underlying surface. As the swatch 12 uses a reversible adhesive material, the swatch 12 is easy to peel and remove from the wall. The reversible adhesive does not leave a residue on the wall after removal, is non-marking, and does not remove pre-existing paint or other material from the wall. The user may move the swatch 12 to another underlying surface or wall within the same room or another room for another perspective or for different light. Alternatively, the user may store the swatch 12 for any length of time. The reversible adhesive of the swatch retains its adhesive properties over time, over multiple uses, and for a variety of underlying surfaces such that the swatch 12 may be used over and over in various locations.

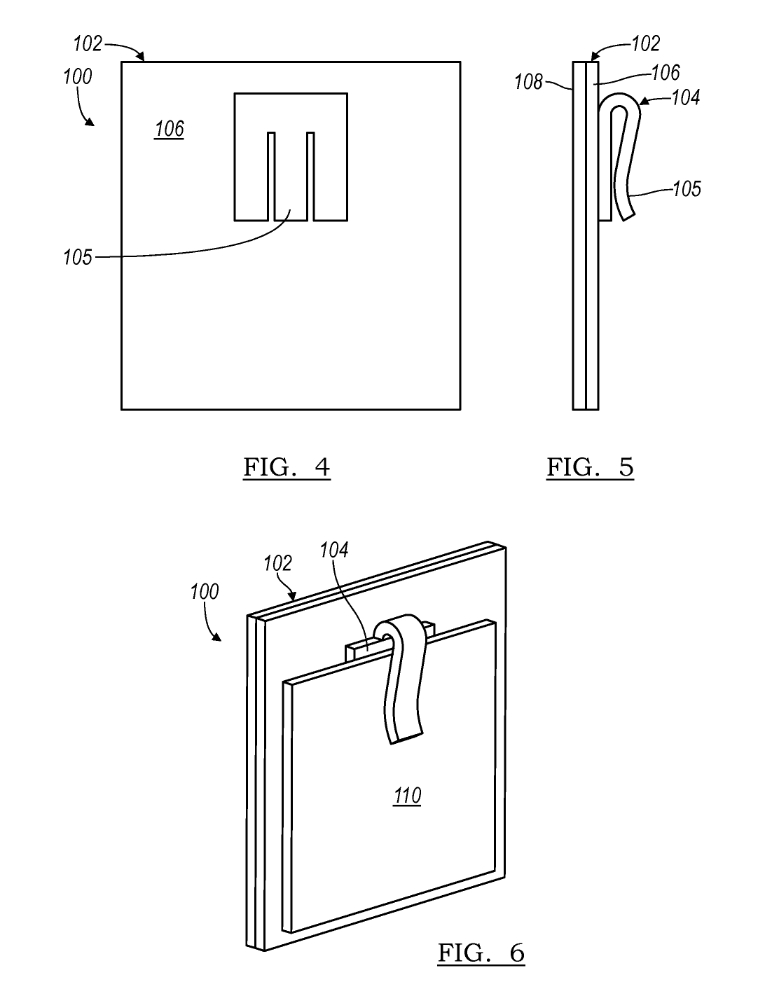

FIGS. 3-4 illustrate another embodiment of a design swatch system. A paint container 50 is illustrated in FIG. 3. The paint container 50 may be a paint can or the like. The paint container 50 has a base 52 and a side wall 54 that define a receptacle 56. The side wall may be generally cylindrical. The receptacle is configured to receive a quantity of paint or the like. The top of the side wall 54 defines a lip 57. A lid 58 is also provided and has an edge 60 that is configured to mate with the lip 56 to close and seal the paint container 50. The base 52, side wall 54, and lid 58 may be made from metal, plastic, or other suitable material. The lid 58 may be generally circular and has an upper or outer surface 62.

A sample paint swatch 64 is provided on the upper surface 62 of the lid 58. The swatch 64 may extend over a majority of the upper surface of the lid as shown. The swatch 64 may also generally match the shape of the lid, as shown, and be generally circular. In other embodiments, the swatch 64 may be a difference shape or size than the lid. The swatch 64 is illustrated as being partially removed from the lid 58. The paint swatch 64 has a substrate layer 66 that is made from paper, PET, or similar material. The layer 66 has a visible surface 68 that is representative of the paint that is contained within the container 50 in terms of color, glossiness, and the like. The swatch 64 also has an adhesive layer 70 that is made from a reversible adhesive as described above with respect to FIGS. 1-2. The swatch 64 has similar properties to those described above for a swatch 12.

In one example, the adhesive layer 70 of the swatch 64 is in direct contact with the upper surface 62 of the lid 58. In another example, a release paper layer (not shown) is supported by the upper surface 62 of the lid 58, and the adhesive layer 70 releasably attaches to the release paper, which may provide for easier removal and return of the swatch 64 to the lid 58.

For example, the user may buy or otherwise obtain the paint container 50 from a retailer, and bring it to the location to be painted, such as a home, office, or the like. Before opening the container 50 and beginning to use the paint contained within, the user has to option of removing the swatch 64 from the lid 58 by peeling the swatch 64 away from the lid 58. The user may then place the swatch 64 on one or more walls or locations to view the paint color represented by the swatch 64. If the user decides that the paint color is acceptable, the user may then remove the swatch 64 from the location to be decorated and begin to use the paint contained within the container 50 to paint the walls, etc. If the user decides that a different color is needed, the user removes the swatch 64 from the location to be decorated, and places the swatch 64 back on the lid 58. The user may then return the unopened container 50 to the retailer and exchange it for a different color, shade, etc.

FIGS. 4-6 illustrate a swatch display apparatus 100 according to an embodiment. In one embodiment, the apparatus 100 is a translucent, removable, replaceable swatch holder which accepts standard paper swatches or other design swatches. For example, apparatus 100 may be purchased or obtained before a paint purchase along with the selection of one or more paint color paper swatch cards or other design swatches.

The apparatus 100 has a base plate 102 and an attachment mechanism 104. Although the base plate 102 is illustrated as being generally rectangular, other shapes are also envisioned for use with the apparatus 100. The base plate 102 has a substrate layer 106 and an adhesive layer 108. The substrate layer 106 may be made from a plastic material, such as PET, or from another suitable material. In some embodiments, the layer 106 is made from a colorless material, and/or is transparent or translucent so as not to interfere with the visualization of a color of a swatch, for example, to allow viewing of a standard paper color swatch against a wall surface without the distraction of another color. The layer 106 may be flexible to aid in removal from an underlying surface by allowing the apparatus 100 to be peeled away. In other embodiments, the layer 106 may be rigid, for example, when an attachment mechanism 104 is formed integrally therewith.

The adhesive layer 108 is made from a reversible adhesive material as described earlier with respect to FIGS. 1-2. In some embodiments, the reversible adhesive material is also colorless and/or transparent or translucent. The reversible adhesive layer 108 may completely cover the back side of the substrate layer 106, or may cover only a portion of the layer 106, and may be patterned on the layer 106. The adhesive layer 108 may also be flexible to bend with the layer 106.

The attachment mechanism 104 may be a clip, hook, holder, fastener, or other mechanism that allows for the removable attachment of a color or design swatch to the apparatus 100. The attachment mechanism 104 may be one piece or may have multiple pieces, for example, as a hinged fastener. In one example, as shown in FIGS. 4-6, the attachment mechanism 104 is a clip with a member 105 that is biased towards the substrate layer 106 to exert a compressive force along the thickness of the card when it is inserted. In another example, the attachment mechanism 104 is a hook, and the swatch has a hole or other feature which allows the swatch to hang on the hook.

The attachment mechanism 104 may be plastic, or another suitable material. In some embodiments, the attachment mechanism 104 is made from a colorless material, and/or may be transparent or translucent. The attachment mechanism 104 may be formed separately from the substrate layer 106, and then affixed to the layer 106. This allows for the two pieces to be made from different materials, or using different fabrication techniques. Alternatively, the attachment mechanism 104 may be integrally formed with the layer 106. Although only one attachment mechanism 104 is shown, the apparatus 100 may have multiple attachment mechanisms 104 to allow for the use of side-by-side viewing of multiple paint color swatches or design swatches.

FIG. 6 illustrates the apparatus 100 in use with a paint color swatch or other design swatch 110. The user places the apparatus 100 against a wall or other underlying surface and presses the apparatus 100 against the wall such that air is removed between the adhesive layer 108 and the wall and the apparatus 100 is adhered to the wall. The user may then insert a paint color swatch into the attachment mechanism 104, and visualize the color in the room or wall to be painted or decorated. The user may insert any number of swatches to visualize various colors. The user may use multiple apparatuses 100 positioned adjacent to one another to examine multiple color combinations. The user then removes any color swatch, and removes the apparatus 100 from the wall by peeling the apparatus away from the wall. The user may use an edge of the apparatus to peel the apparatus away for removal. The reversible adhesive layer allows for the apparatus 100 to be used in other locations to aid in the design selections by the user. Additionally, due to the long lifespan of the adhesive, the apparatus 100 may be stored for later use.

By providing a removable and reusable swatch with the reversible adhesive, the user may quickly attach a paint color sample or other design swatch to the surface of a wall without the need for tape, which could distract from the color of interest or leave behind a sticky residue or marks on the wall surface. Removable and replaceable color swatches attached to the top of a paint container allow a consumer to purchase the can of paint and try the color on the wall without opening the can of paint, which allows for an exchange, refund, or resale of the paint container. The swatches may also reduce the number of trips to a retailer for a consumer, providing a more enjoyable design experience.

Various embodiments of the present disclosure have associated non-limiting advantages. For example, a removable and replaceable design or color swatch or system of swatches is provided. The consumer can temporary attach a selected swatch to the wall to assist in the design process or color selection process. The swatch or apparatus for displaying the swatch includes a reversible adhesive material that allows for the easy removal of the swatch or apparatus from the wall or underlying surface without leaving residue or marks. Also the reversible adhesive retains its adhesive properties over many cycles of use and over time, which allows the swatch or apparatus to be used in various location and a multitude of times.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A swatch assembly comprising:
a substrate having a first side with a decorative sample thereon and a second side; and
an adhesive layer at least partially covering the second side of the substrate, the adhesive layer being a reversible adhesive configured to releasably and temporarily attach the design swatch to an underlying surface and leave the underlying surface unmarked after removal, the reversible adhesive retaining an adhesion property for a plurality of adhesion cycles.

2. The swatch assembly of claim 1 wherein the decorative sample extends over all of the first side.

3. The swatch assembly of claim 1 wherein the decorative sample further comprises one of a continuous solid color, a pattern, and a fabric.

4. The swatch assembly of claim 1 wherein the reversible adhesive further comprises a block copolymer.

5. The swatch assembly of claim 4 wherein the reversible adhesive further comprises a styrene thermoplastic elastomer.

6. The swatch assembly of claim 1 wherein the reversible adhesive has a shear strength and a peel strength, the shear strength being greater than the peel strength.

7. The swatch assembly of claim 1 wherein the reversible adhesive includes composition by weight of 100 parts styrene-ethylene-butadiene-styrene (SEBS) block co-polymer, 100-300 parts hydrogenated naphthenic oil, 100-300 parts white oil, 0-10 parts petroleum adhesion promoter resin, 1-5 parts polypropylene resin, and 2-10 parts assistant agent.

8. The swatch assembly of claim 1 wherein the substrate layer comprises a thermoplastic polymer resin.

9. The swatch assembly of claim 8 wherein the thermoplastic polymer resin comprises Polyethylene terephthalate (PET).

10. The swatch assembly of claim 1 wherein the adhesive layer is displaced generally about a perimeter region of the second side of the substrate layer.

11. A paint container comprising:
a can having a base and a side wall forming a receptacle configured to receive paint;
a lid having an upper surface and an edge configured to cooperate with the can to form a seal to close the receptacle; and
a swatch assembly according to claim 1, the assembly extending over at least a portion of the upper surface of the lid, wherein the decorative sample is a paint sample representing paint contained within the receptacle.

12. The paint container of claim 11 wherein a shape of the swatch assembly corresponds to a shape of the lid.

13. A design system comprising:
a first design swatch comprising:
a first substrate including a first side having a first decorative sample thereon and a second side, and
a first adhesive layer at least partially covering the second side of the first substrate, the adhesive layer being a reversible adhesive configured to releasably and temporarily attach the first design swatch to an underlying surface and leave the underlying surface unmarked after removal, the reversible adhesive retaining an adhesion property for a plurality of uses; and
a second design swatch comprising:
a second substrate including a first side having a second decorative sample thereon and a second side; and
a second adhesive layer at least partially covering the second side of the second substrate, the adhesive layer being the reversible adhesive configured to releasably and temporarily attach the second design swatch to an underlying surface and leave the underlying surface unmarked after removal, the reversible adhesive retaining the adhesion property for a plurality of uses.

14. A design system of claim 13 wherein the first decorative sample varies in design from the second decorative sample.

15. The design system of claim 13 wherein the first and second decorative samples are one of a solid paint color, a decorative wallpaper pattern, a fabric, and a tile.

16. The design system of claim 13 further comprising a third design swatch comprising:
a third substrate including a first side having a third decorative sample thereon and a second side; and
a third adhesive layer at least partially covering the second side of the third substrate, the adhesive layer being the reversible adhesive configured to releasably and temporarily attach the second design swatch to an underlying surface and leave the underlying surface unmarked after removal, the reversible adhesive retaining the adhesion property for a plurality of uses;
wherein the third decorative sample varies in design from the first and second decorative samples.

17. A display apparatus for a design swatch comprising:
a substrate layer having a first side and a second side;
an adhesive layer at least partially covering the second side of the substrate layer, the adhesive layer being a reversible adhesive configured to releasably and temporarily attach the apparatus to an underlying surface and leave the underlying surface unmarked after removal, the reversible adhesive retaining an adhesion property for a plurality of uses; and
an attachment feature supported by the substrate layer and configured to receive a design swatch adjacent to the first side for display against the underlying surface.

18. The display apparatus of claim 17 wherein the substrate layer is one of transparent and translucent; and
wherein the attachment feature is one of transparent and translucent.

19. The display apparatus of claim 17 wherein the attachment feature is further adapted to receive a standard paper color swatch.

20. The display apparatus of claim 17 wherein the base layer defines at least one aperture to form the attachment feature.
